(19) United States
(12) Patent Application Publication
(10) Pub. No.: US 2026/0112116 A1
(43) Pub. Date: Apr. 23, 2026

(54) METHOD, DEVICE, TERMINAL AND MEDIUM FOR RECONSTRUCTING SURFACE FROM POINT CLOUDS BASED ON PARAMETRIC REPRESENTATION

(71) Applicant: SHENZHEN UNIVERSITY, Shenzhen (CN)

(72) Inventors: Ruizhen HU, Shenzhen (CN); Ligang LIU, Shenzhen (CN); Changhao LI, Shenzhen (CN)

(73) Assignee: SHENZHEN UNIVERSITY, Shenzhen (CN)

(21) Appl. No.: 18/963,951

(22) Filed: Nov. 29, 2024

(30) Foreign Application Priority Data
Oct. 17, 2024 (CN) 202411452452.3

(51) Int. Cl. G06T 17/20

(52) U.S. Cl. CPC G06T 17/20; G06T 2210/56

(57) ABSTRACT

A method, device, terminal and medium for reconstructing surface from point clouds based on parametric representation are provided. The method includes: acquiring point clouds to be processed corresponding to a target object, and determining a parametric surface of an anchor point based on parametric representation, representing an object surface of the point clouds to be processed by using the parametric surface; converting the parametric surface into a corresponding triangular mesh to reconstruct a 3D surface of the target object; the parametric representation consists of any quantity of anchor points and the anchor points are located inside or outside the target object and face the three-dimensional surface of the target object, and the target object is observed to obtain observation information represented based on positions and orientations of the anchor points and coefficient of a pre-constructed basis function, representing the parametric surface of the anchor points by using the observation information.

### CROSS-REFERENCE TO RELATED APPLICATIONS

This application claims priority to Chinese Patent Application No. 202411452452.3, filed on Oct. 17, 2024, the content of all of which is incorporated herein by reference.

### FIELD

The present disclosure relates to the technical field of surface reconstruction from point clouds, in particular to a method, a device, a terminal and a medium for reconstructing surface from point clouds based on parametric representation.

### BACKGROUND

In the fields of computer graphics and computational geometry, the representation of three-dimensional (3D) shapes is very important for present applications such as virtual reality, games, advanced manufacturing and scientific visualization. Traditional representation methods of 3D shapes include voxel grid, point clouds and triangular mesh, and each representation method has unique advantages and limitations. The triangular mesh is widely used in computer graphics, virtual reality, game development and scientific visualization because of its simple structure, convenient processing and an ability to provide accurate surface geometric information and support efficient visualization. However, although the point clouds data is one of the most easily collected data from the real world, and the point clouds data can provide sparse and high-resolution surface information, the point clouds data lack an ordered structure and topological relationship of triangular mesh, which makes the point clouds more complicated in processing and difficult to be directly used in present applications requiring precise geometric operations. Therefore, many researches are devoted to the feasible scheme of converting point clouds into various representations and converting the various representations into triangular mesh efficiently and accurately.

At present, the schemes of reconstructing triangular mesh based on point clouds can be roughly divided into four categories. For example, the voxel grid can naturally extend the previous contour extraction method in two-dimensional space to three-dimensional, and realize the estimation of volume shape. The point clouds can provide sparse and high-resolution data and allow surface shape estimation based on local point clouds distribution. In addition, with the maturity of deep learning technology, a lot of researches begin to describe the geometric information of objects by implicit representation such as symbolic distance field, and extract triangular meshes from it. However, the existing surface reconstruction algorithms from point clouds are also faced with the problem of difficult balance between representation accuracy and computational efficiency, and because the representation such as the voxel mesh and the symbolic distance field requires dense division of 3D space, the calculation cost of reconstructing the high-resolution surface of objects based on the representation is too high, which also leads to a problem that only lower-resolution surfaces can be reconstructed in an acceptable time. In another aspect, the point clouds data is difficult to process because of its lack of orderly structure and possible noise, and challenges are existed in representing complex topology. Therefore, when the surface is reconstructed directly from the point clouds, it is easy to misjudge the surface information corresponding to the object, resulting in unreasonable reconstruction results.

To sum up, how to accurately recover corresponding surface information from any given object point clouds on a premise of maintaining high computational efficiency and represent the point clouds as an explicit triangular mesh is a problem that needs to be solved by those skilled in prior art.

### SUMMARY

In view of the above shortcomings of the prior art, the technical problem to be solved by the present disclosure is to a provide a method, a device, a terminal and a medium for reconstructing surface from point clouds based on parametric representation, which can describe the complex geometric information of the object efficiently, and recover more accurate surface information of the object on a premise of maintaining high computational efficiency.

The technical schemes of the present disclosure are as follows.

A method for reconstructing surface from point clouds based on parametric representation, includes:
acquiring point clouds to be processed corresponding to a target object, and determining a parametric surface of an anchor point based on parametric representation, so as to represent an object surface of the point clouds to be processed by using the parametric surface;
converting the parametric surface into a corresponding triangular mesh to reconstruct a three-dimensional surface of the target object;
the parametric representation consists of any quantity of anchor points, and the anchor points are located inside or outside the target object and face the three-dimensional surface of the target object, and the target object is observed to obtain observation information represented based on positions and orientations of the anchor points and coefficient of a pre-constructed basis function, so as to represent the parametric surface of the anchor points by using the observation information.

In one embodiment, the basis function includes a spherical harmonic basis function and a trigonometric basis function; where the spherical harmonic basis function is used to represent a distance from a center of the anchor point to the three-dimensional surface of the target object in different directions, and the triangular basis function is used to represent a mask along an orientation of the anchor point.

In one embodiment, the representing an object surface of the point clouds to be processed by using the parametric surface includes:
screening a corresponding initial point cloud from the point clouds to be processed, and determining the initial point cloud as a center of a surface area of the object concerned by the anchor point;
initializing parameters of the anchor point with the initial point cloud as the center to represent the parametric surface of the anchor point as a plane wafer with a preset radius;
determining a corresponding sampling direction, and sampling along the sampling direction on the parametric surface to obtain a corresponding initial sampling point set;
performing farthest point-sampling on the initial sampling point set by using the farthest point-sampling algorithm to obtain a corresponding sampling point set;
performing uniformly sampling on a boundary of the parametric surface of the anchor point to obtain a corresponding boundary sampling point set;
calculating first distances between sampling point sets corresponding to all the parametric surfaces and the point clouds to be processed, and sequentially calculating second distances between one boundary sampling point set corresponding to one parametric surface in all the parametric surfaces and other boundary sampling point sets corresponding to other parametric surfaces;
minimizing the first distances and the second distances to make the parametric surfaces fit and represent the object surface of the point clouds to be processed.

In one embodiment, the method for reconstructing surface from point clouds based on parametric representation further includes:
determining sampling points on the parametric surfaces based on positions and orientations of the anchor points and distances between sampling points in the sampling point sets and the anchor points.

In one embodiment, the step of converting the parametric surface into a corresponding triangular mesh to reconstruct a three-dimensional surface of the target object includes:
calculating a normal of the sampling points in the sampling point sets by using a preset gradient calculation formula to obtain a corresponding first normal field;
extracting triangular mesh corresponding to an isosurface from the first normal field to reconstruct a three-dimensional surface of the target object.

In one embodiment, after calculating a normal of the sampling points in the sampling point sets by using a preset gradient calculation formula to obtain a corresponding first normal field, the method further includes:
estimating normal vectors with consistent global direction of the sampling points in the sampling point sets by using a preset normal estimation algorithm to obtain a second normal field;
weighting a first normal in the first normal field and a second normal in the second normal field according to a preset weighting calculation formula to obtain a corresponding target normal field;
the preset weighting calculation formula is:

$${\vec{n}}_{opt} = \sqrt{1 - ω} \cdot {\vec{n}}_{our} + ω \cdot {\vec{n}}_{PGR} ,$$

where [symbol] represents a target normal in the target normal field, [symbol] represents the first normal in the first normal field, and \vec{n}_{PGR} represents the second normal in the second normal field;
the step of extracting triangular mesh corresponding to an isosurface from the first normal field to reconstruct a three-dimensional surface of the target object includes:
extracting triangular mesh corresponding to an isosurface from the target normal field to reconstruct the three-dimensional surface of the target object.

In one embodiment, the method further includes:
when a direction of the first normal in the first normal field is opposite to a direction of the second normal in the second normal field, marking the parametric surface corresponding to the first normal field and reversing the direction of the first normal in the first normal field.

The present disclosure further provides a device for reconstructing surface from point clouds based on parametric representation, the device includes:
a point clouds acquiring module, used for acquiring point clouds to be processed corresponding to a target object;
a parametric surface representation module, used for determining a parametric surface of an anchor point based on parametric representation, so as to represent an object surface of the point clouds to be processed by using the parametric surface;
a parametric surface conversion module, used for converting the parametric surface into a corresponding triangular mesh to reconstruct a three-dimensional surface of the target object;
where the parametric representation consists of any quantity of anchor points, and the anchor points are located inside or outside the target object and face the three-dimensional surface of the target object, and the target object is observed to obtain observation information represented based on positions and orientations of the anchor points and coefficient of a pre-constructed basis function, so as to represent the parametric surface of the anchor points by using the observation information.

The present disclosure further provides a terminal, including: a memory, a processor, and a program of reconstructing surface from point clouds based on parametric representation stored in the memory and executed by the processor, when the program is executed by the processor, steps of the method for reconstructing surface from point clouds based on parametric representation are implemented.

The present disclosure further provides a computer-readable storage medium, where a program of reconstructing surface from point clouds based on parametric representation is stored in the computer-readable storage medium; when the program is executed by the processor, the steps of the method for reconstructing surface from point clouds based on parametric representation are implemented.

The present disclosure provides a method, a device, a terminal and a medium for reconstructing surface from point clouds based on parametric representation. The method includes: acquiring point clouds to be processed corresponding to a target object, and determining a parametric surface of an anchor point based on parametric representation, so as to represent an object surface of the point clouds to be processed by using the parametric surface; converting the parametric surface into a corresponding triangular mesh to reconstruct a three-dimensional surface of the target object; where the parametric representation consists of any quantity of anchor points, and the anchor points are located inside or outside the target object and face the three-dimensional surface of the target object, and the target object is observed to obtain observation information represented based on positions and orientations of the anchor points and coefficient of a pre-constructed basis function, so as to represent the parametric surface of the anchor points by using the observation information. Therefore, the point clouds of the object is converted into a parametric representation for representing the object surface, and the parametric representation is converted into a triangular mesh, so that the surface reconstruction from point clouds can be realized, the complex geometric information of the object can be described efficiently, and more accurate surface information of the object can be recovered on the premise of maintaining higher calculation efficiency.

### BRIEF DESCRIPTION OF THE DRAWINGS

FIG. 1 is a flowchart diagram of an embodiment of a method for reconstructing surface from point clouds based on parametric representation in the present disclosure.

FIG. 2 is a schematic diagram of a surface area of an object that can be observed by a single anchor point in the present disclosure.

FIG. 3 is a schematic diagram of a specific parametric representation disclosed in the present disclosure.

FIG. 4 is a schematic diagram of a specific point-sampling of a differentiable surface based on parametric representation.

FIG. 5 is a schematic diagram of inversion transformation based on an anchor point.

FIG. 6 is a schematic diagram of a point-sampling strategy and a boundary continuity loss term of a parametric surface in the present disclosure.

FIG. 7 is a schematic diagram of normal estimation of a sampling point of the parametric surface in the present disclosure.

FIG. 8 is a schematic diagram of a normal difference visualization and a optimized normal of the parametric surface in the present disclosure.

FIG. 9 is a comparative schematic diagram of surface reconstruction results on ShapeNetV2 dataset by different methods in the present disclosure.

FIG. 10 is a functional principle block diagram of an embodiment of a device for reconstructing surface from point clouds based on parametric representation in the present disclosure;

FIG. 11 is a functional principle block diagram of an embodiment of a terminal in the present disclosure.

### DETAILED DESCRIPTION OF EMBODIMENTS

In order to make the purposes, technical schemes, and effects of the present disclosure more clear and definite, the present disclosure is further described in detailed reference to the accompanying drawings and embodiments. It should be understood that the specific embodiments described herein are only used to explain the present disclosure, not to limit the present disclosure.

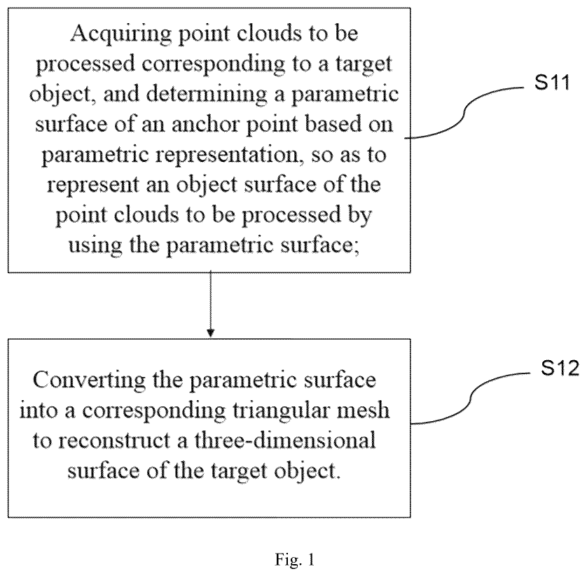

As shown in FIG. 1, which is a flowchart diagram of an embodiment of a method for reconstructing surface from point clouds based on parametric representation in the present disclosure. As shown in FIG. 1, the method for reconstructing surface from point clouds based on parametric representation includes:

S11, acquiring point clouds to be processed corresponding to a target object, and determining a parametric surface of an anchor point based on parametric representation, so as to represent an object surface of the point clouds to be processed by using the parametric surface. The parametric representation consists of any quantity of anchor points, and the anchor points are located inside or outside the target object and face the surface of the target object, and the target object is observed to obtain observation information represented based on positions and orientations of the anchor points and coefficient of a pre-constructed basis function, so as to represent the parametric surface of the anchor points by using the observation information.

In one embodiment, after acquiring point clouds to be processed corresponding to a target object, the point clouds of the target object are converted into parametric representation used for representing the object surface, that is, determining the parametric surface of an anchor point based on parametric representation, so as to represent an object surface of the point clouds to be processed by using the parametric surface. The obtained point clouds of the object are converted into the parametric representation for representing the object surface, which realizes a stronger surface representation ability of the object, and can also greatly reduce the amount of data needed to represent the surface information of the same object, thus saving some storage expenses.

It can be understood that the point clouds representation is converted into parametric representation to represent the object surface through parametric representation, that is, the point clouds representation is converted into the parametric surface of each anchor point in parametric representation to represent the object surface, so that the ability of directly representing the geometric (shape) information of the object surface similar to that of a triangular mesh can be realized, and the parametric representation also has stronger representation ability. Complex geometric information of objects can be efficiently represented, and fast triangular mesh conversion is further supported, providing high-quality geometric information of objects for many present disclosures based on triangular meshes.

It should be pointed out that the parametric representation consists of any quantity of anchor points, which are located inside or outside the target object and face the surface of the target object, and the target object is observed to obtain observation information represented based on positions and orientations of the anchor points and coefficient of a pre-constructed basis function, so as to represent the parametric surface of the anchor points by using the observation information. The spherical harmonic basis function is used to represent a distance from a center of the anchor point to the three-dimensional surface of the target object in different directions, and the triangular basis function is used to represent a mask along an orientation of the anchor point.

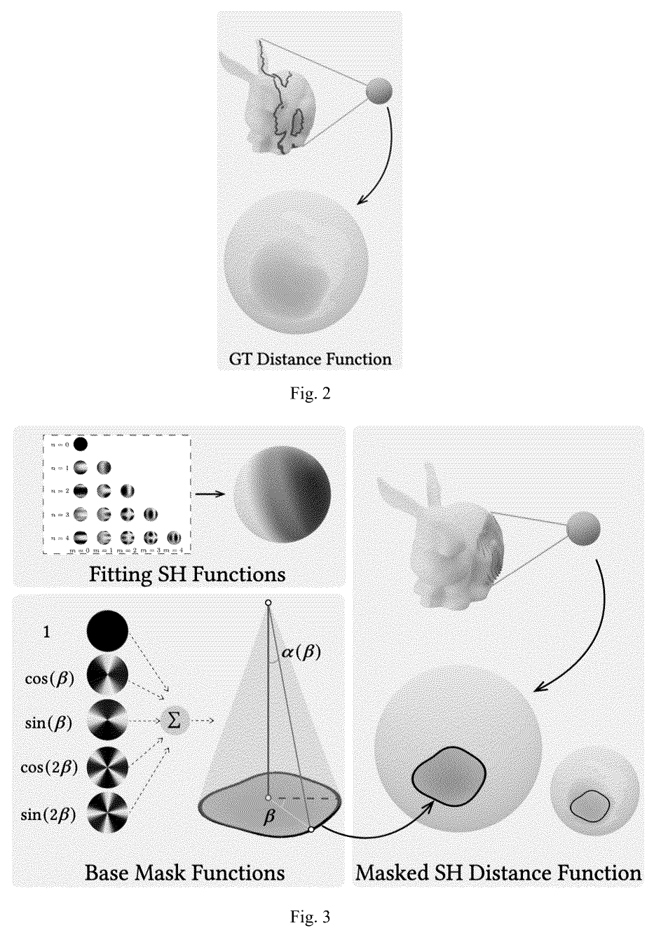

For instance, as shown in FIG. 2, firstly, the parametric representation consists of any number of anchor points, each anchor point is located inside or outside the object and faces the object surface to observe the object, and then the observation information is represented by the position and the orientation of the anchor point and the coefficient of the basis function, so as to realize the complete parametric representation of the observation information. Refer to the spherical harmonic basis function shown in an upper part of FIG. 3, that is, the basic function of the distance function from a single anchor point to the object surface, and use the spherical harmonic basis function to represent the distance from the center of the anchor point to the object surface in different directions. But the functions corresponding to these distances may be discontinuous due to occlusion as shown in FIG. 2, so refer to the triangular basis function shown in a lower part of FIG. 3, that is, the basis function of the mask function used to delimit an effective visual field range on the single anchor point, and the mask along the anchor point direction can be represented by the triangular basis function, thus representing the object surface area that can be effectively represented by the anchor point. The continuous object surface area that can actually be accurately represented by a single anchor point is shown in a right part of FIG. 3.

In the embodiment, the step of converting the point clouds of the target object into parametric representation used for representing the object surface specifically includes: screening a corresponding initial point cloud from the point clouds to be processed, and determining the initial point cloud as a center of a surface area of the object concerned by the anchor point; initializing parameters of the anchor point with the initial point cloud as the center to represent the parametric surface of the anchor point as a plane wafer with a preset radius; determining a corresponding sampling direction, and sampling along the sampling direction on the parametric surface to obtain a corresponding initial sampling point set; performing farthest point-sampling on the initial sampling point set by using the farthest point-sampling algorithm to obtain a corresponding sampling point set; performing uniformly sampling on a boundary of the parametric surface of the anchor point to obtain a corresponding boundary sampling point set; calculating first distances between the sampling point sets corresponding to all the parametric surfaces and the point clouds to be processed, and sequentially calculating second distances between the boundary sampling point set corresponding to one of the parametric surfaces in all the parametric surfaces and the boundary sampling point sets corresponding to other parametric surfaces; minimizing the first distances and the second distances to make the parametric surfaces fit and represent the object surface of the point clouds to be processed.

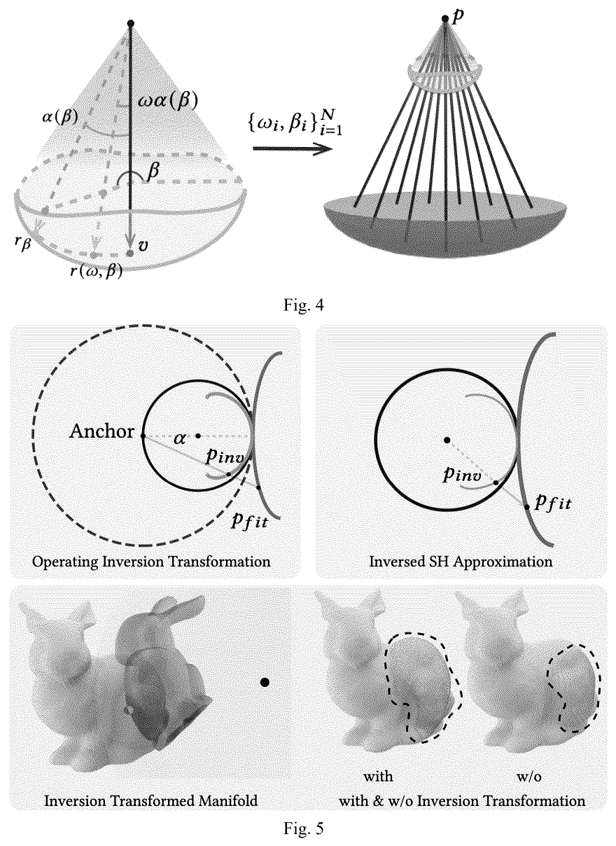

It should be pointed out that in the process of calculating the sampling points on the parametric surfaces, the sampling points on the parametric surfaces are determined based on the positions and sampling directions of the anchor points, the distances between the sampling points in the sampling point set and the anchor points, thus realizing the calculation of the sampling points on the parametric surfaces. For example, as shown in FIG. 4, for each anchor point, firstly, the position p and orientation v can be determined, and any sampling direction inside the mask and including the edge can be represented as a difference between the orientation of the corresponding anchor point and the direction of the edge mask, that is:

$$r ( ω , β ) = ω \cdot {r}_{β} + ( 1 - ω ) \cdot v ;$$

where r(ω, β) represents the sampling direction, ω represents the difference weight of the orientation and the direction of the edge mask, β represents an included angle of the edge mask direction along the projection towards the right relative to an initial coordinate axis, r_{β} represents the direction of the edge mask, and v represents the orientation of the anchor point.

Then, after the sampling direction is obtained, the distance from the sampling point to the anchor point in each sampling direction is calculated, that is, for any sampling direction r(ω, β) in FIG. 4, the corresponding standard spherical coordinate is (θ, φ)=(ωα(β), β), where α(β) represents the included angle between the edge mask direction and the orientation, that is:

$$α ( β ) = {a}_{0} + {\sum }_{k = 1}^{K} {a}_{k} cos ( k β ) + {\sum }_{k = 1}^{K} {b}_{k} sin ( k β ) ,$$

where α₀ represents an initial parameter corresponding to the mask, αₖ represents a second parameter corresponding to the mask, bₖ represents a third parameter corresponding to the mask, K represents an order of a basis functions used for the edge mask.

Furthermore, the distance from the sampling point to the anchor point in each sampling direction can be calculated by the standard spherical harmonic basis function calculation formula, that is:

$$d ( θ , ϕ ) = {\sum }_{l = 0}^{L} {\sum }_{m = - l}^{l} {C}_{l}^{m} {y}_{l}^{m} ( θ , ϕ ) ,$$

where

$${C}_{l}^{m}$$

responding to an anchor point distance function,

$${Y}_{l}^{m}$$

represents parameters corresponding to the spherical harmonic basis function, and L represents an order of the spherical harmonic basis function used by the anchor point distance function.

Finally, based on the positions of the anchor points, the sampling directions, and the distances from the sampling points in each sampling direction to the positions of the anchor points, the sampling points on the parametric surface of the anchor point as shown in FIG. 4 can be obtained.

Moreover, because the spherical harmonic function is better at representing a sphere or a surface, but can not accurately represent a plane, the sampling points can be inversed to allow be allowed to represent a plane, and characterization ability of the parametric representation can be further improved.

For instance, referring to a corresponding relationship between the sum of two points pᵢₙᵥ and p_{fit} before and after the inverse evolution transformation shown in the upper part of FIG. 5. Assume that a dotted circle is an inverse circle with a center O and a radius R. The inverse evolution transformation requires the sum of any two points pᵢₙᵥ and p_{fit} to satisfy vector multiplication (pᵢₙᵥ−O)(p_{fit}−O)=R². First, determine the position p of the anchor point and the distance r along the direction v, and use them to construct the solid line small circle in the upper part of FIG. 5. Then, take the intersection of the ray corresponding to an opposite direction of the anchor point and the small circle as a center O of the inversion circle, and a radius of the inversion circle is twice that of the small circle. At this time, through inverse transformation, the small circle can establish a one-to-one correspondence with a straight line tangent to the inversion circle and the small circle at the same time, and any pair of inversion points can be calculated by the following formula:

$${p}_{inv} = O + \frac{{R}^{2}}{{‖ {p}_{fit} - O ‖}^{2}} ( {p}_{fit} - O ) ,$$

referring to the position relationship of the object surface before and after inversion shown in the lower part of FIG. 5, and whether the difference of the object surface representing ability brought by the inversion is considered, an object's surface can be transformed from the shape on the left to the shape on the right through the inversion. At this time, compared with the anchor point, the observed object surface area is transformed into an approximate spherical shape, thus allowing the use of the same quantity of parameters to represent a wider range of object surface information.

For instance, the parameterized surface of a single anchor point is represented by the position and orientation of the anchor point and the coefficients of the pre-constructed basis function, that is:

$$V = {\{ p , v , {a}_{i} , {b}_{j} , {C}_{l}^{m} \}}_{i ∈ [ 0 , K ] , j ∈ [ 1 , K ] , l ∈ [ 0 , L ] , m ∈ [ - l , l ]} ,$$

where p is the spatial position of the anchor point, v is the orientation of the anchor point, αᵢ, bⱼ is the parameter of the mask of the anchor point, and

$${C}_{l}^{m}$$

is the parameter of the anchor point distance function.

However, by placing a preset quantity of anchor points {V₁, . . . , V_{M}} near the surface of the target object, the complete surface information of the object can be accurately represented. Therefore, for a given object point cloud, only need to convert the object point clouds into parametric representation, and then the surface information of the object corresponding to the point clouds can be obtained.

It should be pointed out that when calculating the sampling points on the parametric surface of each anchor point, a gradient of each parameter in the parametric representation V with respect to the 3D coordinates {x, y, z} of the sampling points can be calculated according to the calculation formula of the sampling points mentioned above, thus realizing the differentiable calculation from the parametric representation to the sampling points, so as to further realize a corresponding random gradient descent algorithm.

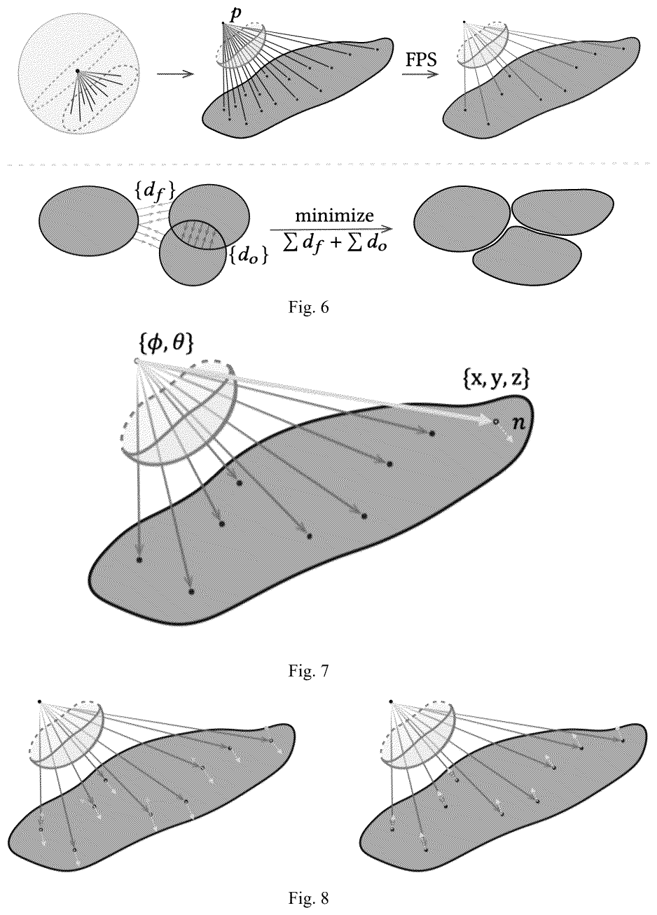

Assuming that M parametric surfaces need to be used to jointly compose and represent a surface of a given object point cloud, firstly, M points are selected from the point clouds to be processed as the centers of the object surface areas concerned by M anchor points as initial points, and then the parameters of the corresponding anchor points are randomly initialized near each initial point, making the parametric surfaces of the anchor points represent a plane wafer with a radius of rᵢₙᵢₜ, where the radius rᵢₙᵢₜ can be preset according to an actual situation or experience. Further, as shown in the upper part of FIG. 6, the corresponding sampling direction can be determined, and the initial sampling point set P of the single anchor point can be obtained by sampling along the sampling direction on the parametric surface corresponding to each anchor point. However, due to the arbitrariness of the shape of the parametric surface of the anchor point, even if the sampling direction is uniformly set, it is difficult to obtain uniformly distributed sampling point sets P, which may lead to over-sampling of relatively flat areas and undersampling of relatively complex surface areas, which leads to many unnecessary calculations when estimating the parametric representation and decreases the accuracy of the surface representation. Therefore, the farthest point-sampling algorithm is used to resample the initial sampling point set P of the parametric surface corresponding to each anchor point, that is, the farthest point-sampling is carried out on the basis of the initial sampling point set P to obtain a more uniform sampling point set P_{FPS}, which is used as the final internal sampling point set of the anchor point.

Then, L1-Chamfer Distance between the sampling point set

$${\{ {P}_{FPS}^{i} \}}_{i = 1}^{M}$$

corresponding to the parametric surfaces of all anchor points and the given target point clouds are calculated, and then minimized to realize fitting and representing the complete object surface through a set of parametric surfaces.

Because the parametric representation is using a group of parametric surfaces to represent the object surface, it is very important for the parametric representation to ensure a good continuity of the boundaries of adjacent parametric surfaces. Only by ensuring the good continuity of the boundaries of adjacent parametric surfaces can such a group of parametric surfaces be successfully converted into a complete object surface. Therefore, the boundary continuity between adjacent parametric surfaces can be evaluated and optimized by calculating a boundary continuity loss.

For instance, in addition to using the farthest point-sampling algorithm to sample on the parametric surface corresponding to each anchor point to obtain a more uniform sampling point set P_{FPS}, a group of boundary sampling points can be evenly sampled on the boundary of each parametric surface to obtain the corresponding boundary sampling point set P_{bound}.

Then, the boundary of the parametric surface of each anchor point is considered ergodicly to obtain boundary sampling point sets corresponding to the parametric surfaces of all anchor points, and second distances between the boundary sampling point set corresponding to each parametric surface in all parametric surfaces and other point sets are calculated, that is, the distances between the boundary sampling points in the boundary sampling point set P_{bound} and the boundary sampling points in the overall point set constituted by the boundary sampling point set P_{bound} corresponding to all other parameterized surfaces are calculated in turn. By minimizing errors of the distances, the adjacent parametric surfaces have a high-quality connection relationship. Referring to the loss function shown in the lower part of FIG. 6 for encouraging the boundaries of the parametric surfaces between different anchor points to have a high-quality continuity.

For example, a given object point clouds are represented by a parametric surface of five anchor points, and the boundary of the parameterized surface of each anchor point is considered ergodicly to obtain boundary sampling point sets corresponding to the parameterized surfaces of the five anchor points, namely A, B, C, D and E, and then the distances between each boundary sampling point set and the whole point set formed by the rest of the five boundary sampling point sets are calculated in turn. For example, distances between the boundary sampling point set A and a whole boundary sampling point set conformed by the four boundary sampling point sets B, C, D and E, distances between the boundary sampling point set B and a whole boundary sampling point set conformed by the four boundary sampling point sets A, C, D and E, distances between the boundary sampling point set C and a whole boundary sampling point set conformed by the four boundary sampling point sets A, B, D and E, distances between the boundary sampling point set D and a whole boundary sampling point set conformed by the four boundary sampling point sets A, B, C and E, distances between the boundary sampling point set E and a whole boundary sampling point set conformed by the four boundary sampling point sets A, B, C and D. By minimizing the distances, the parametric surfaces have high quality connection relationships.

As shown in the upper part of FIG. 6, for two parametric surfaces that are far apart, the floating distance d_{f} between their boundary sampling points indicates a floating error of adjacent parametric surfaces, while for two parametric surfaces with certain overlapping areas, the overlapping distance dₒ between their boundary sampling points indicates an overlapping error of adjacent parametric surfaces.

S12, converting the parametric surface into a corresponding triangular mesh to reconstruct a three-dimensional surface of the target object.

In the embodiment, after determining a parametric surface of an anchor point based on parametric representation, so as to represent an object surface of the point clouds to be processed by using the parametric surface, converting the parametric surface into a corresponding triangular mesh to reconstruct a three-dimensional surface of the target object. Understandably, triangular mesh has become a carrier and general representation of various geometry-related tasks, so in order to apply the representation to other fields or tasks more quickly and widely, it is necessary to convert the parametric representation into an explicit triangular mesh data structure.

Specifically, calculating a normal of the sampling point in the sampling point sets by using a preset gradient calculation formula to obtain a corresponding first normal field; extracting the triangular mesh corresponding to an isosurface from the first normal field to reconstruct a three-dimensional surface of the target object. Understandably, performing sampling on the parametric surface and calculating an accurate normal of each sampling point to obtain an implicit normal field, and extracting the isosurface from the implicit normal field to obtain the triangular mesh.

As shown in FIG. 7, due to the computation process of the sampling point is differentiable, gradient information during the computation process can be used again for obtaining the normal n of each sampling point, so as to obtain the accurate normal information of each parametric surface, that is:

$${n}_{x} = \frac{\partial y}{\partial ϕ} \frac{\partial z}{\partial θ} - \frac{\partial z}{\partial ϕ} \frac{\partial y}{\partial θ} , {n}_{y} = \frac{\partial y}{\partial ϕ} \frac{\partial x}{\partial θ} - \frac{\partial x}{\partial ϕ} \frac{\partial z}{\partial θ} {n}_{z} = \frac{\partial x}{\partial ϕ} \frac{\partial y}{\partial θ} - \frac{\partial y}{\partial ϕ} \frac{\partial x}{\partial θ} .$$

It should be pointed out that the normal calculated by the gradient formula is completely accurate in the interior of parameterized surfaces, but only the boundary continuity of adjacent parameterized surfaces are restricted, which may lead to insufficient normal continuity between adjacent parameterized surfaces, thus reducing a smoothness of the converted normal field and further affecting the quality of the final triangular mesh. Therefore, after calculating a normal of the sampling point in the sampling point sets by using a preset gradient calculation formula to obtain a corresponding first normal field, the method further includes: estimating normal vectors with consistent global direction of the sampling point in the sampling point sets by using a preset normal estimation algorithm to obtain a second normal field; weighting a first normal in the first normal field and a second normal in the second normal field according to a preset weighting calculation formula to obtain a corresponding target normal field; the preset weighting calculation formula is:

$${\vec{n}}_{opt} = \sqrt{1 - ω} \cdot {\vec{n}}_{our} + ω \cdot {\vec{n}}_{PGR} ,$$

where [symbol] represents the target normal in the target normal field, [symbol] represents the first normal in the first normal field, and [symbol] represents the second normal in the second normal field;

Further, extracting the triangular mesh corresponding to the isosurface from the target normal field to reconstruct the three-dimensional surface of the target object.

For instance, as shown in the right part of FIG. 8, the optimized normal is obtained by weighting the normal calculated by the gradient formula and the normal estimated by the preset normal estimation algorithm through an adaptive weighting method. Specifically, the normal information [symbol] calculated by the gradient formula is kept as much as possible inside the parameterized surfaces, and the smooth normal [symbol] estimated by the preset normal estimation algorithm is as close as possible at the boundary of the parameterized surfaces, and the weight ω of each sampling point is calculated to make it equal to a proportion of the sampling point on a connecting line from the center point of the parameterized surface to the boundary, where the closer the ω is to 0, it indicates that the closer the sampling point is to the center point of the parameterized surface, and vice versa, the closer the sampling point is to the boundary of the parameterized surface. Then the optimized normal (target normal) [symbol] is calculated, so that the normal orientations of all sampling points on each parameterized surface are optimized, making the normal orientations have local accuracy, global consistency, and good smoothness at the same time, thus significantly improving the quality of the finally extracted triangular mesh. Then, the triangular mesh corresponding to the isosurface is extracted from the obtained normal field as the estimated object surface.

In the present embodiment, when the first normal direction in the first normal field is opposite to the normal direction of the second normal direction in the second normal field, the parametric surface corresponding to the first normal field is marked, and the first normal direction in the first normal field is flipped. Understandably, due to the different orientations of different anchor points, the normal orientations of two adjacent parameterized surfaces may be opposite. In order to find and repair this situation, the preset normal estimation algorithm is used to obtain the normal orientations of the sampling point set corresponding to the global direction. As shown in the left part of FIG. 8, when most of the normal orientations calculated by the preset gradient calculation formula are opposite to the normal orientations estimated by the preset normal estimation algorithm, the current parameterized surfaces are marked and all normal orientations of the current parameterized surfaces are flipped.

It can be seen that in the embodiment of the present disclosure, the point clouds of the object is converted into the parametric representation for representing the object surface, and the parametric representation is converted into a triangular mesh, so that the surface reconstruction of the point clouds can be realized, the complex geometric information of the object can be described efficiently, and more accurate surface information of the object can be recovered on the premise of maintaining high computational efficiency.

It should be pointed out that in the embodiment of the present disclosure, in the process of representing the object surface of the point clouds with parameterized surfaces, additional other geometric constraints can be set, such as the normal continuity between parameterized surfaces, and in the process of triangular mesh transformation of parametric representation, different reconstruction effects can be obtained by combining with other different normal estimation methods. Moreover, compared with other existing methods for reconstructing surface from point clouds, any quantity of given object point clouds can be fitted through the method for reconstructing surface from point clouds based on parametric representation of the present disclosure with the parametric surface, thus supporting more accurate object surface estimation and recovery.

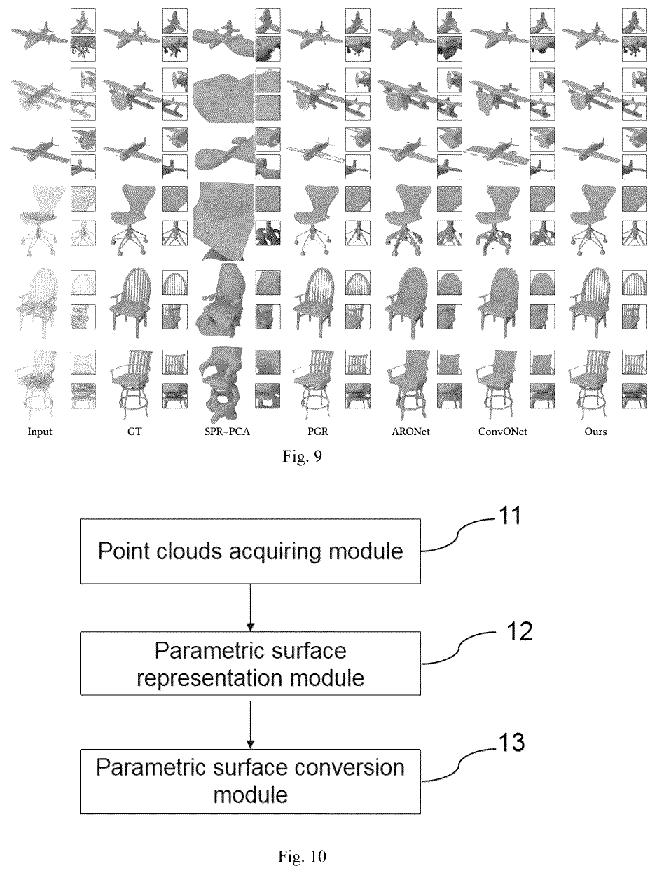

As shown in FIG. 9, the method for reconstructing surface from point clouds based on parametric representation of the present disclosure is compared with other existing methods for reconstructing surface from point clouds in an all-round way. First, the open source complete data set ShapeNetV2 is selected as the comparison data, which contains 55 different semantic categories and more than 50,000 triangular mesh representations of different objects. The farthest point-sampling algorithm is used to sample the surface of each shape to obtain the point clouds representation of the shape, and then different method for reconstructing surface from point clouds are applied to the point clouds, and an error between the reconstructed surface and the real object surface is compared. The classical Poisson reconstruction (SPR+PCA) is highly dependent on the accuracy of the estimated normal of point clouds, so it reconstructs completely wrong results on many complex objects. However, the two methods based on deep learning, ARONet and ConvONet, also have large reconstruction errors because of the error of network prediction and the limitation of the acceptable resolution of input point clouds in the network. Although the average error of surface reconstruction based on Parametric Gauss Reconstruction (PGR) is not too big, the reconstruction results in many narrow or thin structures are appear obvious errors or degradation. In contrast, the average error of the method for reconstructing surface from point clouds based on parametric representation realized by the technical scheme of the present disclosure can be lower, and the object surface with the above-mentioned narrow or thin structure can be reconstructed better. Therefore, the technical scheme of the present disclosure can realize more accurate surface reconstruction of objects than other methods.

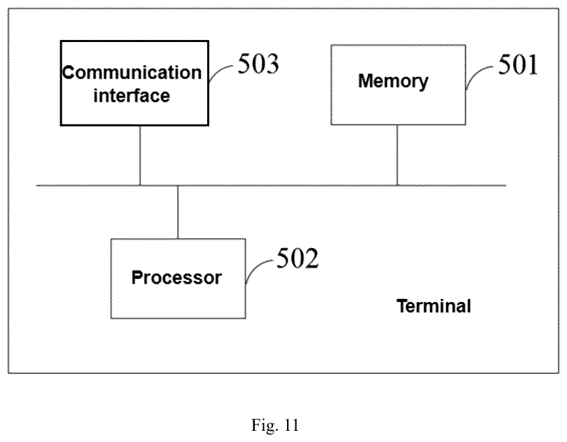

In one embodiment, as shown in FIG. 10, based on the method for reconstructing surface from point clouds based on parametric representation, the present disclosure further provides a device for reconstructing surface from point clouds based on parametric representation, including:
a point clouds acquiring module 11, used for acquiring point clouds to be processed corresponding to a target object;
a parametric surface representation module 12, used for determining a parametric surface of an anchor point based on parametric representation, so as to represent an object surface of the point clouds to be processed by using the parametric surface;
a parametric surface conversion module 13, used for converting the parametric surface into a corresponding triangular mesh to reconstruct a three-dimensional surface of the target object;
the parametric representation consists of any quantity of anchor points, and the anchor points are located inside or outside the target object and face the three-dimensional surface of the target object, and the target object is observed to obtain observation information represented based on positions and orientations of the anchor points and coefficient of a pre-constructed basis function, so as to represent the parametric surface of the anchor points by using the observation information.

FIG. 11 is a functional principle block diagram of an embodiment of a terminal in the present disclosure. The terminal may include:
a memory 501, a processor 502, and a program of reconstructing surface from point clouds based on parametric representation stored in the memory 501 and executed by the processor 502.

When the program is executed by the processor 502, steps of the method for reconstructing surface from point clouds based on parametric representation are implemented.

Furthermore, the terminal includes:
a communication interface 503 for communication in the memory 501 and the processor 502.

The memory 501 is used for storing computer programs that can run on the processor 502.

The memory 501 may include a high-speed RAM memory or a non-volatile memory, such as at least one disk memory.

If the memory 501, the processor 502, and the communication interface 503 are independently realized, the communication interface 503, the memory 501, and the processor 502 can be connected to each other by a bus and complete communication with each other. The bus can be an Industry Standard Architecture (ISA) bus, a Periphera I Component (PCI) bus or an Extended Industry Standard Architecture (EISA) bus. The bus can be divided into address bus, data bus and control bus. For the convenience of representation, only one line is shown in the figure, but it does not mean that there is only one bus or one type of bus.

Alternatively, if the memory 501, the processor 502 and the communication interface 503 are integrated on one chip, the memory 501, the processor 502 and the communication interface 503 can communicate with each other through an internal interface.

The processor 502 may be a Central Processing Unit (CPU), or an present disclosure specific integrated circuit (ASIC), or one or more integrated circuits configured to implement the embodiments of the present disclosure.

A computer-readable storage medium is also provided in the embodiment, on which a computer program is stored. When executed by a processor, the computer program realizes the method for reconstructing surface from point clouds based on parametric representation.

In the description of the specification, descriptions referring to the terms “one embodiment”, “some embodiments”, “examples”, “specific examples” or “some examples” mean that specific features, structures, materials or characteristics described in connection with the embodiment or example are included in at least one embodiment or example of the present disclosure. In the specification, the schematic representations of the above terms are not necessarily aimed at the same embodiment or example. Moreover, the specific features, structures, materials or characteristics described can be combined in any one or n embodiments or examples in a suitable way. In addition, those skilled in the art can combine and combine different embodiments or examples and features of different embodiments or examples described in the specification without contradicting each other.

In addition, the terms “first” and “second” are only used for descriptive purposes, and cannot be understood as indicating or implying relative importance or implicitly indicating the quantity of indicated technical features. Therefore, the features defined as “first” and “second” can explicitly or implicitly include at least one of these features. In the description of the present disclosure, the meaning of “N” is at least two, such as two, three, etc., unless otherwise specifically defined.

Any process or method description in the flowchart or otherwise described herein can be understood as representing a module, segment or part of code that includes one or n executable instructions for implementing customized logic functions or steps of the process, and the scope of embodiments of the present disclosure includes other implementations, in which functions can be performed out of the order shown or discussed, including in a substantially simultaneous manner or in the reverse order according to the functions involved, which should be understood by those skilled in prior art to which the embodiments of the present disclosure belong.

The logic and/or steps represented in the flowchart or described in other ways herein, for example, can be regarded as a sequenced list of executable instructions for realizing logical functions, and can be embodied in any computer-readable medium for use by or in combination with an instruction execution system, apparatus or equipment (such as a computer-based system, a system including a processor or other systems that can read and execute instructions from the instruction execution system, apparatus or equipment). For the purposes of this specification, a “computer-readable medium” can be any device that can contain, store, communicate, propagate or transmit a program for use by or in connection with an instruction execution system, device or device. More specific examples (non-exhaustive list) of computer-readable media include the following: an electrical connection part (electronic device) with one or n wires, a portable computer disk box (magnetic device), a random access memory (RAM), a read-only memory (ROM), an erasable and editable read-only memory (EPROM or flash memory), an optical fiber device, and a portable CD-ROM. In addition, the computer-readable medium can even be paper or other suitable medium on which the program can be printed, because the program can be electronically obtained by optically scanning the paper or other medium, followed by editing, interpreting or otherwise processing if necessary, and then stored in the computer memory.

It should be understood that various parts of the present disclosure can be implemented in hardware, software, firmware, or a combination thereof. In the above embodiments, n steps or methods can be realized by software or firmware stored in a memory and executed by an appropriate instruction execution system. If it is realized by hardware, as in another embodiment, it can be realized by any one of the following technologies known in the art or their combination: discrete logic circuits with logic gates for realizing logic functions on data signals, application specific integrated circuits with appropriate combinational logic gates, programmable gate arrays (PGA), field programmable gate arrays (FPGA), etc.

Those skilled in the art can understand that all or part of the steps carried by the method of the above embodiment can be completed by instructing related hardware through a program, which can be stored in a computer-readable storage medium, and the program, when executed, includes one or a combination of the steps of the method embodiment.

In addition, each functional unit in each embodiment of the present disclosure can be integrated in one processing module, or each unit can exist physically alone, or two or more units can be integrated in one module. The above integrated modules can be realized in the form of hardware or software functional modules. Integrated modules can also be stored in a computer-readable storage medium if they are implemented in the form of software functional modules and sold or used as independent products.

The storage medium mentioned above can be read-only memory, magnetic disk or optical disk, etc. Although the embodiments of the present disclosure have been shown and described above, it can be understood that the above embodiments are exemplary and cannot be understood as limitations of the present disclosure, and those skilled in the art can make changes, modifications, substitutions and variations to the above embodiments within the scope of the present disclosure.

It should be understood that the present disclosure is not limited to the above embodiments, and those skilled in the art can make improvements or transformations according to the above descriptions, and all these improvements and transformations should belong to the protection scope of the appended claims of the present disclosure.

What is claimed is:

1. A method for reconstructing surface from point clouds based on parametric representation, comprising:
acquiring point clouds to be processed corresponding to a target object, and determining a parametric surface of an anchor point based on parametric representation, so as to represent an object surface of the point clouds to be processed by using the parametric surface; and
converting the parametric surface into a corresponding triangular mesh to reconstruct a three-dimensional surface of the target object;
wherein the parametric representation consists of any quantity of anchor points, and the anchor points are located inside or outside the target object and face the three-dimensional surface of the target object, and the target object is observed to obtain observation information represented based on positions and orientations of the anchor points and coefficient of a pre-constructed basis function, so as to represent the parametric surface of the anchor points by using the observation information.

2. The method for reconstructing surface from point clouds based on parametric representation according to claim 1, wherein the basis function comprises a spherical harmonic basis function and a trigonometric basis function; wherein the spherical harmonic basis function is configured to represent a distance from a center of the anchor point to the three-dimensional surface of the target object in different directions, and the triangular basis function is configured to represent a mask along an orientation of the anchor point.

3. The method for reconstructing surface from point clouds based on parametric representation according to claim 1, wherein the representing an object surface of the point clouds to be processed by using the parametric surface comprises:
screening a corresponding initial point cloud from the point clouds to be processed, and determining the initial point cloud as a center of a surface area of the object concerned by the anchor point;
initializing parameters of the anchor point with the initial point cloud as the center to represent the parametric surface of the anchor point as a plane wafer with a preset radius;
determining a corresponding sampling direction, and sampling along the sampling direction on the parametric surface to obtain a corresponding initial sampling point set;
performing farthest point-sampling on the initial sampling point set by using the farthest point-sampling algorithm to obtain a corresponding sampling point set;
performing uniformly sampling on a boundary of the parametric surface of the anchor point to obtain a corresponding boundary sampling point set;
calculating first distances between sampling point sets corresponding to all the parametric surfaces and the point clouds to be processed, and sequentially calculating second distances between one boundary sampling point set corresponding to one parametric surface in all the parametric surfaces and other boundary sampling point sets corresponding to other parametric surfaces; and
minimizing the first distances and the second distances to make the parametric surfaces fit and represent the object surface of the point clouds to be processed.

4. The method for reconstructing surface from point clouds based on parametric representation according to claim 3, further comprising:
determining sampling points on the parametric surfaces based on positions and orientations of the anchor points and distances between sampling points in the sampling point sets and the anchor points.

5. The method for reconstructing surface from point clouds based on parametric representation according to claim 4, wherein the converting the parametric surface into a corresponding triangular mesh to reconstruct a three-dimensional surface of the target object comprising:
calculating a normal of the sampling points in the sampling point sets by using a preset gradient calculation formula to obtain a corresponding first normal field; and
extracting triangular mesh corresponding to an isosurface from the first normal field to reconstruct a three-dimensional surface of the target object.

6. The method for reconstructing surface from point clouds based on parametric representation according to claim 5, wherein after calculating a normal of the sampling points in the sampling point sets by using a preset gradient calculation formula to obtain a corresponding first normal field, further comprises:
estimating normal vectors with consistent global direction of the sampling points in the sampling point sets by using a preset normal estimation algorithm to obtain a second normal field; and
weighting a first normal in the first normal field and a second normal in the second normal field according to a preset weighting calculation formula to obtain a corresponding target normal field;
wherein the preset weighting calculation formula is:
$${\vec{n}}_{opt} = \sqrt{1 - ω} \cdot {\vec{n}}_{our} + ω \cdot {\vec{n}}_{PGR} ,$$
wherein [symbol] represents a target normal in the target normal field, [symbol] represents the first normal in the first normal field, and [symbol] represents the second normal in the second normal field;
wherein the extracting triangular mesh corresponding to an isosurface from the first normal field to reconstruct a three-dimensional surface of the target object comprises:
extracting triangular mesh corresponding to an isosurface from the target normal field to reconstruct the three-dimensional surface of the target object.

7. The method for reconstructing surface from point clouds based on parametric representation according to claim 6, wherein the method further comprises:
when a direction of the first normal in the first normal field is opposite to a direction of the second normal in the second normal field, marking the parametric surface corresponding to the first normal field and reversing the direction of the first normal in the first normal field.

8. A device for reconstructing surface from point clouds based on parametric representation, wherein the device comprises:
a point clouds acquiring module, used for acquiring point clouds to be processed corresponding to a target object;
a parametric surface representation module, used for determining a parametric surface of an anchor point based on parametric representation, so as to represent an object surface of the point clouds to be processed by using the parametric surface; and
a parametric surface conversion module, used for converting the parametric surface into a corresponding triangular mesh to reconstruct a three-dimensional surface of the target object;
wherein the parametric representation consists of any quantity of anchor points, and the anchor points are located inside or outside the target object and face the three-dimensional surface of the target object, and the target object is observed to obtain observation information represented based on positions and orientations of the anchor points and coefficient of a pre-constructed basis function, so as to represent the parametric surface of the anchor points by using the observation information.

9. A terminal, comprising: a memory, a processor, and a program of reconstructing surface from point clouds based on parametric representation stored in the memory and executed by the processor, when the program is executed by the processor, steps of the method for reconstructing surface from point clouds based on parametric representation according to claim 1 are implemented.
